(19) United States
(12) Patent Application Publication
(10) Pub. No.: US 2025/0027635 A1
(43) Pub. Date: Jan. 23, 2025

(54) SPLIT TYPE ROTATABLY REMOVABLE AND CONVENIENTLY MOUNTABLE BUTTERFLY DOWN LAMP

(71) Applicant: Hengdian Group Tospo Lighting Co., Ltd., Jinhua (CN)

(72) Inventors: Xiaoxing WANG, Jinhua (CN); Le WANG, Jinhua (CN); Jinli SHAN, Jinhua (CN); Jinghang ZHOU, Jinhua (CN); Ying YE, Jinhua (CN); Heng LI, Jinhua (CN)

(21) Appl. No.: 18/543,746

(22) Filed: Dec. 18, 2023

(30) Foreign Application Priority Data
Jul. 18, 2023 (CN) 202321891839.X

(51) Int. Cl. F21V 21/03; F21S 8/04

(52) U.S. Cl. CPC F21V 21/03; F21S 8/043; F21Y 2101/00; F21Y 2113/00; F21Y 2115/10

(57) ABSTRACT

A split type rotatably removable and conveniently mountable butterfly down lamp includes a mounting seat and a lamp body; a mounting cavity arranged inside the mounting seat; a connecting sheet connected to an inner bottom of the mounting cavity, and the two sides of the connecting sheet of hollow structures; several limiting strips are connected to an inner wall of the mounting cavity; the lamp body includes a shell; a light source module is arranged inside the shell; the light source module includes an aluminum base plate; the aluminum base plate is provided with several lighting LEDs; a reflective cup is arranged above the light source module; a diffusion cover is arranged above the reflective cup; and fastening edges corresponding to the limiting strips are arranged at a circumference of the shell.

### CROSS-REFERENCE TO RELATED APPLICATION

This application claims foreign priority benefits under 35 U.S.C. § 119 from Chinese Patent Application No. 202321891839.X, filed Jul. 18, 2023, the content of which is hereby incorporated by reference in its entirety.

### TECHNICAL FIELD

The present disclosure belongs to the technical field of butterfly down lamps, and particularly, to a split type rotatably removable and conveniently mountable butterfly down lamp.

### BACKGROUND

With the increasing demand for energy-saving and environmental-protection products, light-emitting diode (LED) lighting products are being applied to more and more situations. Due to their energy-saving and environmental-protection characteristics, LED lighting products are being applied to more and more situations in society, and their market demand is increasingly.

At present, according to LED butterfly down lamps on the market, a metal shell is fixed on a ceiling by using screws, and then a diffusion mask is in snap fit or rotatable fit with the metal shell. Since a diameter of the metal shell is large, the metal shell would cover the position of a screw hole on a junction box, and the metal shell is blindly fixed or is fixed according to experience and cannot be fixed in place in one step.

In addition, the shell adopts a metal piece in consideration of heat dissipation, so a larger diameter causes a higher material cost.

### SUMMARY

In order to solve the problems mentioned in the background, the present disclosure provides a split type rotatably removable and conveniently mountable butterfly down lamp, which has the characteristic of convenience in mounting and removal.

In order to achieve the above objective, the present disclosure provides the following technical solution: A split type rotatably removable and conveniently mountable butterfly down lamp includes a mounting seat and a lamp body, wherein a mounting cavity is arranged inside the mounting seat; a connecting sheet is connected to an inner bottom of the mounting cavity, and each of the two sides of the connecting sheet is of a hollow structure exposing a screw hole of a junction box; one or more limiting strips are connected to an inner wall of the mounting cavity; the lamp body includes a shell; a light source module is arranged inside the shell; the light source module includes an aluminum base plate; the aluminum base plate is provided with one or more lighting lamp beads; a reflective cup is arranged above the light source module; a diffusion cover is arranged above the reflective cup; and one or more fastening edges corresponding to the one or more limiting strips are arranged at a circumference of the shell.

Further, in order to facilitate rotating the one or more fastening edges to a position below the one or more limiting strips and limiting the fastening edges to avoid the lamp body from being rotated out without an external force, a bottom surface of the one or more limiting strips is of a slope structure, and a limiting bulge is arranged on the bottom surface of the one or more limiting strips.

Further, in order to ensure the heat dissipation effect of the whole lamp, the shell is an aluminum component, and the aluminum base plate fits snugly to an inner bottom of the shell.

Further, in order to facilitate a fast connection between the diffusion cover and the shell, one or more clamping slots are arranged at the circumference of the shell, and the diffusion cover is provided with one or more buckles corresponding to the one or more clamping slots.

Further, in order to achieve adjustability of a color temperature of the whole lamp, a dial switch is connected to the aluminum base plate, and the lighting lamp beads includes low color temperature lamp beads and high color lamp beads.

Further, in order to adjust the color temperature of the whole lamp, a bottom of the shell is provided with a slidable dial handle connected to the dial switch in a dialing manner.

Further, in order to achieve a function of a night lamp for the butterfly down lamp, the aluminum base plate is further provided with one or more night lamp beads located on an outer circle outside the lighting lamp beads.

Further, in order to eliminate an unaesthetic phenomenon that the lamp beads can be seen during lateral observation and achieve a better night lamp effect, a frosted surface is arranged on a side edge of a light exiting surface of the diffusion cover.

Further, each of the two sides of the connecting sheet has an exposure hole exposing the screw hole of the junction box.

Compared with the prior art, the present disclosure has the beneficial effects below:

1. According to the present disclosure, the butterfly down lamp is divided into two opposite portions: the mounting seat and the lamp body. The light source module and the mounting seat are separated, so that the mounting seat will no longer provide a heat dissipation function for the lamp body, and the mounting seat can be made of a cheaper material to reduce the cost.

2. The mounting seat of the present disclosure not only ensures the appearance of the butterfly down lamp, but also serves as a stand. The two sides of the connecting sheet are of the hollow structures, so that the position of a screw hole on a junction box can be clearly exposed during the mounting of the mounting seat, and the mounting efficiency is higher.

3. The lamp body and the mounting seat of the present disclosure are connected through the rotatable fit between the fastening edges and the limiting strips, so that the lamp body is more convenient to mount and remove.

4. The aluminum base plate of the present disclosure is further provided with the night lamp beads located on the outer circle outside the lighting LEDs, so that the butterfly down lamp has the function of a night lamp.

### BRIEF DESCRIPTION OF THE DRAWINGS

The accompanying drawings are intended to provide a further understanding of the present disclosure and constitute a part of this specification. The accompanying drawings and the embodiments of the present disclosure are used together for explaining the present disclosure rather than constituting a limitation on the present disclosure. In the drawings:

FIG. 1 is an exploded view of a structure of the present disclosure;

FIG. 2 is a schematic structural diagram of a lamp body of the present disclosure;

FIG. 3 is a schematic structural diagram of a mounting seat of the present disclosure;

FIG. 4 is a schematic structural diagram of connection between a fastening edge and a limiting strip of the present disclosure;

FIG. 5 is a schematic structural diagram of a light source module of the present disclosure; and

FIG. 6 is a schematic structural diagram of a limiting strip of the present disclosure.

In the drawings: 1: lamp body; 2: mounting seat; 21: connecting sheet; 22: limiting strip; 23: mounting cavity; 24: limiting bulge; 25: exposure hole; 3: shell; 31: fastening edge; 32: clamping slot; 4: reflective cup; 5: diffusion cover; 51: buckle; 52: frosted surface; 6: light source module; 61: lighting LED; 62: dial switch; 63: night LED; 64: aluminum base plate; and 7: dial handle.

### DETAILED DESCRIPTION

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

### Embodiment 1

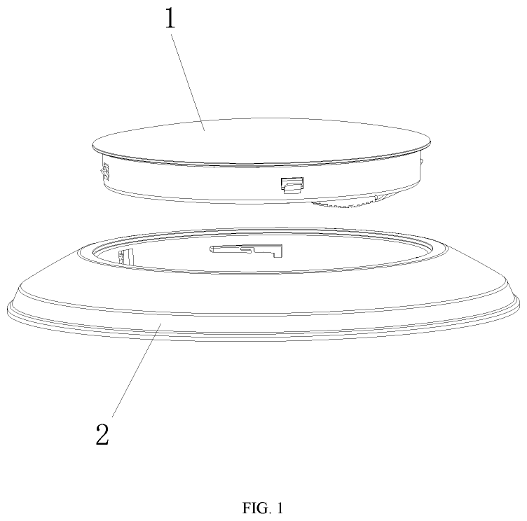

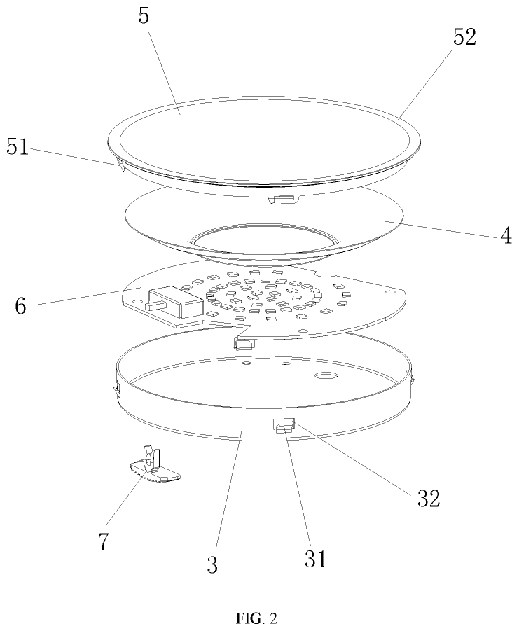

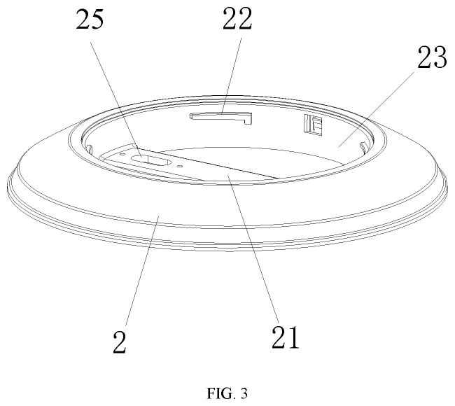

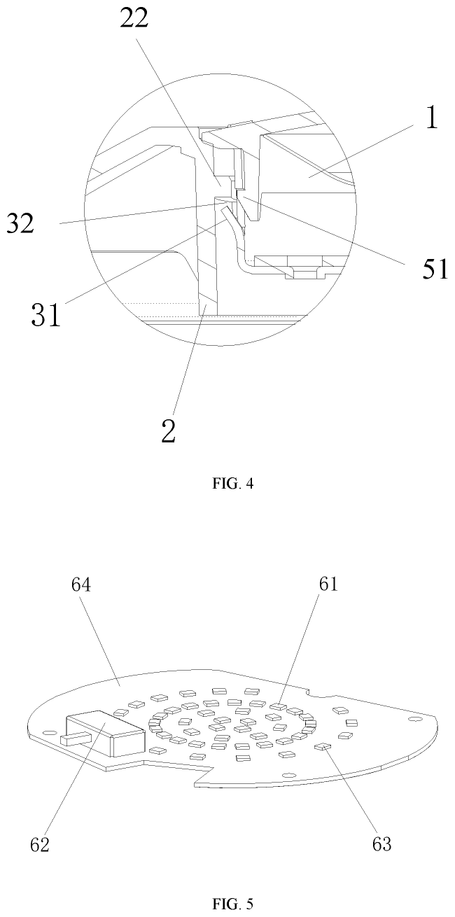

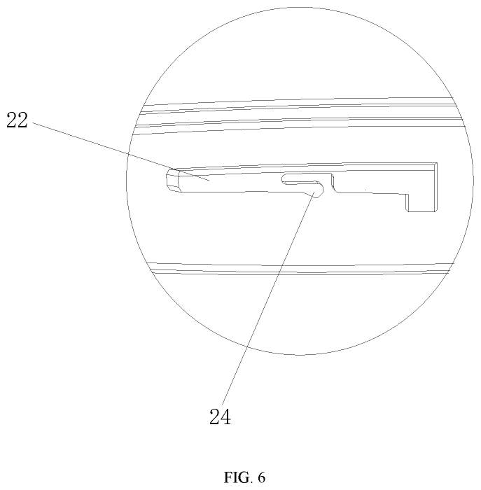

Referring to FIG. 1 to FIG. 6, the present disclosure provides a split type rotatably removable and conveniently mountable butterfly down lamp that includes a mounting seat 2 and a lamp body 1. A mounting cavity 23 is arranged inside the mounting seat 2. A connecting sheet 21 is connected to an inner bottom of the mounting cavity 23. The connecting sheet 21 may be integrally formed with the inner bottom of the mounting cavity 23. Two sides of the connecting sheet 21 are of hollow structures exposing screw holes of a junction box. Each side of the connecting sheet 21 may have an exposure hole 25 exposing the screw hole of the junction box. An inner wall or inner side wall of the mounting cavity 23 is integrally formed with four limiting strips 22. The four limiting strips 22 may be distributed along the circumference of the inner wall or inner side walls of the mounting cavity 23. The lamp body 1 includes a shell 3. A light source module 6 is arranged inside the shell 3. The light source module 6 includes an aluminum base plate 64, and the aluminum base plate 64 is provided with a plurality of lighting lamp beads 61. A reflective cup 4 is arranged above the light source module 6. A diffusion cover 5 is arranged above the reflective cup 4, and fastening edges 31 corresponding to the limiting strips 22 are arranged at a circumference of the shell 3.

By the adoption of the above technical solution, according to the present disclosure, the butterfly down lamp is divided into two opposite portions: the mounting seat 2 and the lamp body 1; and the light source module 6 and the mounting seat 2 are separated, so that the mounting seat 2 will no longer provide a heat dissipation function for the lamp body 1, and the mounting seat 2 can be made of a cheaper material. The mounting seat 2 of the present disclosure not only ensures the appearance of the butterfly down lamp, but also serves as a stand. The two sides of the connecting sheet 21 are of the hollow structures, so that the position of a screw hole on a junction box can be clearly seen or exposed through the hollow structure during the mounting of the mounting seat 2, and the mounting efficiency is higher. The lamp body 1 and the mounting seat 2 of the present disclosure are connected through the rotatable fit between the fastening edges 31 and the limiting strips 22, so that the lamp body 1 is more convenient to mount and remove.

Specifically, a bottom surface of the limiting strip 22 is of a slope structure, and a limiting bulge 24 is arranged on the bottom surface of the limiting strip 22.

By the adoption of the above technical solution, it is convenient to rotate the fastening edges 31 to a position below the limiting strips 22 and limit the fastening edges 31 through the limiting bulges 24, so as to avoid the lamp body 1 from being rotated out without an external force.

Specifically, four clamping slots 32 are further arranged at the circumference of the shell 3, and the diffusion cover 5 is provided with buckles 51 corresponding to the clamping slots 32. The clamping slots 32 are formed by punching, and flanges bent by this punching processing are used as the fastening edges 31.

By the adoption of the above technical solution, it is convenient for quick connection between the diffusion cover 5 and the shell 3.

### Embodiment 2

A difference between this embodiment and Embodiment 1 is as follows: Specifically, the shell 3 is an aluminum component, and the aluminum base plate 64 fits snugly to an inner bottom of the shell 3 and is locked by a screw.

By the adoption of the above technical solution, the heat dissipation effect of the whole lamp is ensured.

### Embodiment 3

A difference between this embodiment and Embodiment 1 is as follows: Specifically, a side switch or dial switch 62 is connected to the aluminum base plate 64, and the lighting lamp beads 61 include low color temperature lamp beads and high color temperature lamp beads.

By the adoption of the above technical solution, a color temperature of the whole lamp is adjustable.

Specifically, a bottom of the shell 3 is provided with a slidable dial handle 7 connected to the dial switch 62 in a dialing manner.

By the adoption of the above technical solution, the color temperature of the whole lamp is adjusted through the dial handle 7.

### Embodiment 4

A difference between this embodiment and Embodiment 1 is as follows: Specifically, the aluminum base plate 64 is further provided with night lamp beads 63 located on an outer circle outside the lighting LEDs 61. The night lamp beads 6 may be located radially outside the lighting lamp beads 61.

By the adoption of the above technical solution, the butterfly down lamp has the function of a night lamp.

### Embodiment 5

A difference between this embodiment and Embodiment 4 is as follows: Specifically, a frosted surface 52 is arranged on a side edge of a light exiting surface of the diffusion cover 5.

By the adoption of the above technical solution, an unaesthetic phenomenon that the LEDs can be seen during lateral observation is eliminated, and the night lamp effect is better.

### Embodiment 6

A difference between this embodiment and Embodiment 1 is as follows: Specifically, two spring fastening positions are arranged on the mounting seat 2.

By the adoption of the above technical solution, the butterfly down lamp can be mounted in a metal barrel in combination with spring parts, so that the application range of mounting is enlarged.

In summary, the butterfly down lamp is divided into two opposite portions: the mounting seat 2 and the lamp body 1; and the light source module 6 and the mounting seat 2 are separated, so that the mounting seat 2 will no longer provide a heat dissipation function for the lamp body 1, and the mounting seat 2 can be made of a cheaper material. The mounting seat 2 of the present disclosure not only ensures the appearance of the butterfly down lamp, but also serves as a stand. The two sides of the connecting sheet 21 are of the hollow structures, so that the position of a screw hole on a junction box can be clearly seen during the mounting of the mounting seat 2, and the mounting efficiency is higher. The lamp body 1 and the mounting seat 2 of the present disclosure are connected through the rotatable fit between the fastening edges 31 and the limiting strips 22, so that the lamp body 1 is more convenient to mount and remove. The aluminum base plate 64 of the present disclosure is further provided with the night LEDs 63 located on the outer circle of the lighting LEDs 61, so that the butterfly down lamp has the function of a night lamp.

It should be finally noted that: The foregoing embodiments are merely preferred embodiments of the present disclosure, but not intended to limit the present disclosure. Although the present disclosure is described in detail with reference to the foregoing embodiments, a person of ordinary skill in the art may still make modifications to the technical solutions described in the foregoing respective embodiments or make equivalent replacements to partial technical features thereof. Any modification, equivalent replacement, and improvement made within the spirit and scope of the present disclosure shall fall within the protection scope of the present disclosure.

1. A split type rotatably removable butterfly down lamp, comprising a mounting seat and a lamp body, wherein a mounting cavity is arranged inside the mounting seat; a connecting sheet is connected to an inner bottom of the mounting cavity, and each of two sides of the connecting sheet is of a hollow structure exposing a screw hole; one or more limiting strips are connected to an inner wall of the mounting cavity; the lamp body comprises a shell; a light source module is arranged inside the shell; the light source module comprises an aluminum base plate; the aluminum base plate is provided with one or more lighting lamp beads; a reflective cup is arranged above the light source module; a diffusion cover is arranged above the reflective cup; and one or more fastening edges corresponding to the one or more limiting strips are arranged at a circumference of the shell.

2. The butterfly down lamp according to claim 1, wherein a bottom surface of the one or more limiting strips is of a slope structure, and a limiting bulge is arranged on the bottom surface of the one or more limiting strips.

3. The butterfly down lamp according to claim 1, wherein the shell is an aluminum member, and the aluminum base plate fits snugly to an inner bottom of the shell.

4. The butterfly down lamp according to claim 1, wherein one or more clamping slots are arranged at a circumference of the shell, and the diffusion cover is provided with one or more buckles corresponding to the one or more clamping slots.

5. The butterfly down lamp according to claim 1, wherein a dial switch is connected to the aluminum base plate, and the lighting lamp beads comprise low color temperature lamp beads and high color temperature lamp beads.

6. The butterfly down lamp according to claim 5, wherein a bottom of the shell is provided with a slidable dial handle connected to the dial switch in a dialing manner.

7. The butterfly down lamp according to claim 1, wherein the aluminum base plate is further provided with one or more night lamp beads located on an outer circle outside the lighting lamp beads.

8. The butterfly down lamp according to claim 1, wherein a frosted surface is arranged on a side edge of a light exiting surface of the diffusion cover.

9. The butterfly down lamp according to claim 1, wherein each of the two sides of the connecting sheet has an exposure hole exposing the screw hole.
